(19) United States
(12) Patent Application Publication
(10) Pub. No.: US 2005/0207052 A1
(43) Pub. Date: Sep. 22, 2005

(54) Predictable journal architecture

(76) Inventor: Richard Testardi, Boulder, CO (US)

Correspondence Address: PROSKAUER ROSE LLP, ONE INTERNATIONAL PLACE 14TH FL, BOSTON, MA, 02110, US

(21) Appl. No.: 11/083,922

(22) Filed: Mar. 18, 2005

Related U.S. Application Data
(60) Provisional application No. 60/554,888, filed on Mar. 19, 2004.

(51) Int. Cl. G06F 17/60

(52) U.S. Cl. 360/55

(57) ABSTRACT

Described are methods, systems, and apparatus, including computer program products for achieving a predictable journal architecture, as well as data store recovery therefrom. A predictable journal architecture includes a journal with header and data portions of journal entries, the header portions located at multiples of a predetermined offset. Journal entries are written to locations independent of the size of the data portions of that or other headers. During a recovery operation, a recovery module is able to search the journal at locations that are multiples of the predetermined offset to find entry headers. Journal entries for I/O operations that occur temporally before the current I/O need not be written to the journal for the current I/O to be journaled and, during recovery, retrieved.

### CROSS-REFERENCE TO RELATED APPLICATION

This application claims priority to and the benefit of, and incorporates herein by reference, in its entirety, provisional U.S. patent application 60/554,888, filed Mar. 19, 2004.

### FIELD OF THE INVENTION

The invention relates to computing, and relates specifically to data storage and recovery.

### BACKGROUND

In computer systems, journals are useful for file system or database recovery. A journal is a record of the completed or successful Input/Output (I/O) operations, typically write operations, performed on a disk or database (herein “data store”). Journals may be written to the same address space or physical media as the data store, but typically journals are written to a separate partition or data store so as not to affect data store performance. Journals are composed of journal entries, each entry typically written concurrently with an I/O operation performed on a data store. The journal entry is typically composed of “header” data and “I/O operation” data. A journal entry's I/O operation data describes the I/O operation that was performed concurrently on the data store, e.g., what was written to the data store and where. A journal entry's header data usually describes where to find the corresponding I/O's data on the disk and how long the I/O's data is, thereby indicating where the next header and I/O operation data should reside (i.e., at a location dependent on the length of the first I/O's data).

In the event of a failure, it is desirable to return the data store to a consistent state, that is, retain I/O operations that were complete at the time of the failure. I/O operations that were only partially completed at the time of the failure are typically removed from the data store. The data store then only contains operations that fully completed or does not contain an operation at all. Since it is easier to remove an operation than attempt to reconstruct the operation, during recovery, a recovery module compares the data store to the journal to determine which operations completed before the failure. I/O operations or records on the data store that do not appear in the journal are removed or “rolled back.” Using the assumption that successful and/or completed I/O operations were recorded in the journal, operations that are not in the journal indicate those operations did not complete or were only partially successful when the failure occurred. Rolling back these incomplete I/O operations allows the recovery module to return the data store to a consistent state.

Hard disk drives typically include a magnetic disk that resides on a spindle. An actuator moves an actuator arm across the disk, the read/write head attached to the arm correspondingly reading from or writing to the magnetic disk. Software typically manages the actuator arm movement and overall process of reading from and writing to the disk. When writing journals, disk writing algorithms of the journal management software may re-order writes to the journal to maximize actuator arm efficiency. Sometimes I/O operation data for the journal is written to the journal before the header entry is written to the journal (since the software managing the journal has assigned locations to both the header data and the I/O operation data to be written before writing the header data and the I/O operation data to disk). A technique used for recoverability is to keep header data and I/O operation data of the journal entry in separate address spaces, writing headers one after another in one location on the disk and writing I/O operation data one after another in another location on the disk. In the event of a failure, the system can examine what headers are in the header space, what I/O operation data are in the I/O space (since the header data describes the header's corresponding I/O operation data) and determine if the corresponding original I/O operation data was committed to the data store before the failure. This technique, however, requires that each I/O use two writes per I/O operation (i.e., one movement of the actuator arm to read/write to the header data space and one movement of the actuator arm to read/write to the I/O operation data space). This does not optimize arm efficiency because each arm completes two writes to the journal spaces for every one I/O committed to the data store.

Even when the header data and the I/O operation data for the journal are written to the same space to improve performance, if the journal management software's disk writing algorithms journal (e.g., generate a journal entry for) a “later” or second I/O operation before an “earlier” I/O operation, potentially both entries would be lost in the event of a failure. As described above, a header describes how long the I/O operation data portion of a journal entry is. Correspondingly, the header also describes, by inference, where the header for the next journal entry begins. For example, if a 34 kilobyte I/O needs to be written to a journal, the header for that journal entry is written to disk at location p₀, and the data corresponding to the I/O operation for that journal entry is written at p₀+header length. The header of the next I/O is then written at p₀+[34 k] journal entry header length+[34 k] I/O operation data length (the length of the I/O operation data plus the header describing the I/O operation data). The location of the later I/O's header is dependent on the earlier I/O's length.

If it is more efficient for a disk writing algorithm to journal a later I/O operation on this actuator arm pass and write the earlier journal entry on a subsequent pass, or if both I/O operations are journaled simultaneously by separate disk reading/writing modules, the disk writing algorithms offsets the later journal entry by the length of the earlier I/O entry since the algorithm knows how long the earlier I/O entry is. On this actuator arm pass, the later entry is effectively “floating” on the disk since no other journal entry describes where this journal entry is. When the earlier entry is journaled, the header of the earlier entry describes how long the earlier I/O's data portion is. Consequently, the header of the earlier entry describes where the later journal entry header is found.

If the system fails between the times the later entry is journaled and the earlier I/O is journaled, both I/O operations are lost. Since the first I/O was never journaled, the I/O is removed from the data store. Additionally, the later I/O's journal entry remains floating with nothing indicating the entry's location. If nothing points to the later I/O's journal entry, i.e. the earlier I/O's header is not in the journal (or the earlier I/O operation data is rolled back in the event only some of the data for that I/O is journaled) and thus not on the data store, the later I/O's journal entry is also lost. Correspondingly, during recovery, the later I/O is also removed from the data store since it has no entry in the journal.

### SUMMARY OF THE INVENTION

In a data store that utilizes journals used in a computer system, a balance can be struck between optimal disk actuator arm efficiency and recoverability. Disk actuator arms are typically always in motion. Maximizing the number of writes per actuator arm movement can be used as a general measure of an efficient data store device. Since actuator arms are constantly in motion, and disk failures occur rarely, it is advantageous to concentrate resources to maximize actuator arm efficiency. At the same time, a base level of recoverability should be retained. One technique is to use a minimal number of writes per I/O, and correspondingly, minimize actuator arm movement, while still allowing the system, in the event of a failure, to reconstruct what was successfully written to the data store before the failure occurred.

The present invention provides a predictable journal architecture such that performance and efficiency are maximized while maintaining a high level of recoverability. In particular, one or more implementations of the present invention allow a journaled system, after a failure, to find headers and data that were successfully written to disk independent of the other entries. For systems where journaling operations occur concurrently with I/O operations performed against the data store, implementations of the invention are beneficial in that journal entries are not ordered in a single-file queue (that reflects the ordering of the writes to the data store) for committal to disk. Instead, a journal management module may re-order journal entries to maintain actuator arm efficiency and write the journal entries to predictable places on the disk, allowing a recovery module to easily find journal entries during a recovery.

In one aspect, there is a predictable journal architecture. The predictable journal architecture includes a journal. The journal includes a first I/O operation data associated with a first size and a first location. A first journal header is disposed at a second location, the first journal header comprising information associated with the first size or first location. The journal also includes a second journal header disposed at a third location, the third location being dependent on the second location and independent of the first size or the first location. In some implementations, the third location is a multiple of an offset of the second location. The offset may be a fixed journal entry size, or as in some implementations, the offset may be a fixed block size. Where the offset is a fixed block size, the fixed block size may include a fourth size, that fourth size being the size of a pair of blocks.

In some implementations, the architecture also includes a recovery module. The recovery module is configured to determine the location of a second I/O operation data based on the offset from the second location. The recovery module is also configured, in some implementations, to compare the first I/O operation data and the second I/O operation data located in the journal to a third I/O (the third I/O including a third journal entry header and a third I/O operation data) located on a data store. If a copy of the third journal entry header and/or a copy of the third I/O operation data is not located in the journal, the recovery module is configured to remove the third I/O from the data store.

In another aspect, there is a method for achieving a predictable journal architecture. The method includes employing a first I/O having a first journal entry header and a first I/O operation data at a first location in a journal. The method also includes employing a second journal entry having a second journal entry header and a second I/O operation data in the journal located at a predetermined offset from the first location. The location of the second journal entry header and second I/O operation data is independent of the length of the first I/O operation data. In some implementations, such as a recovery operation, employing includes reading operations. In some implementations, such as disk writing, employing includes writing. In some implementations, the predetermined offset is a multiple of a fixed journal entry size.

In another aspect, there is another method for achieving a predictable journal architecture. The method includes scheduling a first journal entry header to be written to a first location in a journal. A second location in the journal is calculated, the second location being a multiple of a predetermined offset plus the beginning first location. A second journal entry header is written to the journal at the second location. In some implementations, the first journal entry header is not written to the journal, it is only scheduled. In some of the implementations where the first journal entry header is written to the journal, the second journal entry header is written to the journal before the first journal entry header is written to the journal. In some implementations, in addition to scheduling the first journal entry header, a first I/O operation data is scheduled to be written to a third location, the third location being adjacent to the first journal entry header and before the second location (i.e., before the location of the second header). In implementations where I/O operation data and journal entry headers are both scheduled to be written, a second I/O operation data is scheduled to be written to a fourth location, the fourth location being adjacent to the second journal entry header. In some implementations, the header data and I/O operation data are written contiguously such that the writing of both is accomplished a single actuator arm pass.

In another aspect, there is a method for achieving a predictable journal architecture. The method involves writing a first journal entry to a journal, the first journal entry including an I/O operation data and a header. The header is written to a first pair of blocks in the journal, the first pair having a first odd-numbered block and a first even-numbered block, the header being written to the first odd-numbered block. The I/O operation data is written to a second pair of blocks in the journal, the second pair having a second odd-numbered block and a second even-numbered block, a constant string being written to the second odd-numbered block and the data being written to the second even-numbered block. In some implementations, the constant string comprises a string of 0s. In some of those implementations, a second journal entry includes an I/O operation data and a header. In some of those implementations, the header of the second journal entry is distinguished from the I/O operation data of the first journal entry based on a determination that the header of the second journal entry is located in a block that does not hold a string of 0s.

Other aspects and advantages of the present invention will become apparent from the following detailed description, taken in conjunction with the accompanying drawings, illustrating the principles of the invention by way of example only.

### BRIEF DESCRIPTION OF THE DRAWINGS

The foregoing and other objects, features, and advantages of the present invention, as well as the invention itself, will be more fully understood from the following description of various embodiments, when read together with the accompanying drawings, in which:

FIG. 1 depicts a predictable journal architecture; and

FIG. 2 is a block diagram depicting a method for achieving the predictable architecture of FIG. 1; and

FIG. 3 depicts another predictable journal architecture.

### DETAILED DESCRIPTION

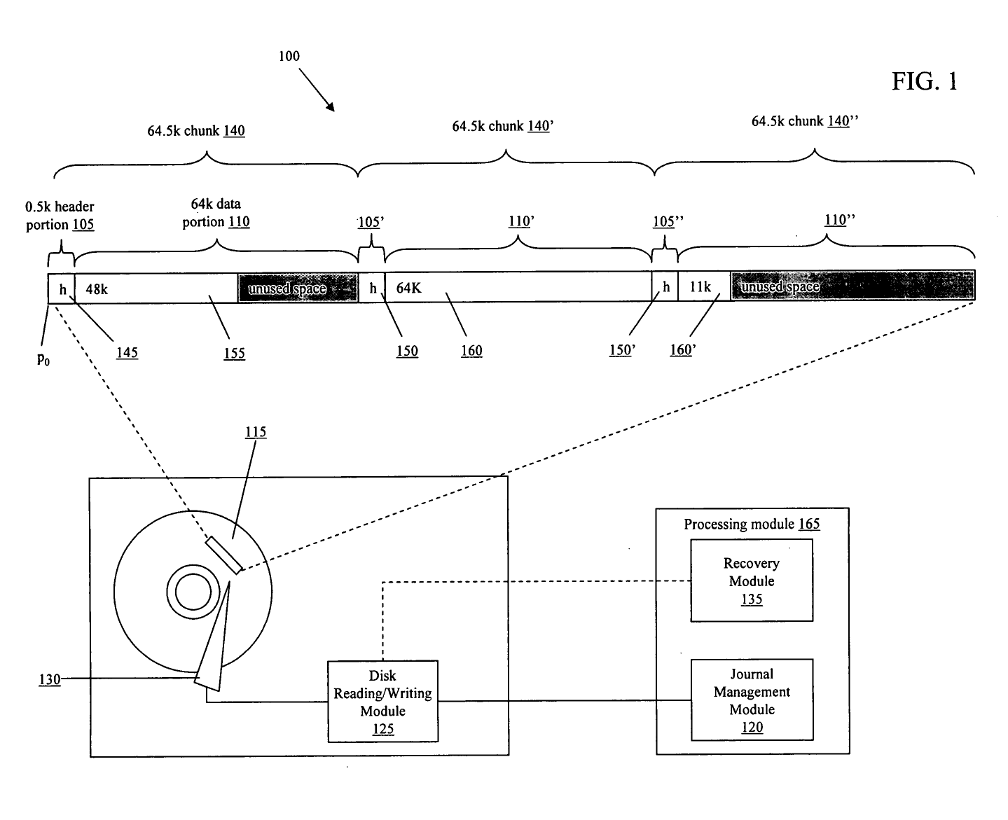

FIG. 1 depicts a predictable journal architecture 100. The architecture 100 includes a journal with a fixed journal entry size, the journal entry size representing the size allocated for a journal entry header 105, 105′, 105″ (generally 105) and allocated for a portion of I/O operation data 110, 110′, 110″ (generally 110). FIG. 1 displays the journal architecture 100 with respect to a magnetic hard disk 115. A journal management module 120 communicates with the disk reading/writing module 125, which in turn instructs an actuator arm 130 to read and write journal entries from/to the disk 115. Optionally, a recovery module 135 may communicate with the disk reading/writing module 125 to instruct the actuator arm 130 to read from and/or write to the journal during a recovery operation.

In the implementation depicted in FIG. 1, each journal entry is allocated a fixed size. The fixed journal entry size, or “chunk,” 140, 140′, 140″ (generally 140) for each entry is 64.5 kilobytes (“64.5 k”). Portions of the journal allocated for each journal entry header 105 are 0.5 k, or 512 bytes. The header data 145, 150, 150′ written to the header portions 105 describe the corresponding I/O's data 155, 160, 160′ (e.g., the location and size of the data 155, 160, 160′). The data portion 110 allocated for the data 155, 160, 160′ of each I/O is 64 k (i.e., 64.5 k−0.5 k for the header=64 k). Advantageously, because each of the chunks 140 of I/O operations are a fixed size in the journal (i.e., a “fixed journal entry size”), the headers portions 105 and data portions 110 are distributed at equal intervals across the journal.

As depicted in FIG. 1, the journal entry for a first I/O represents a 48 k I/O write. The journal management module 120 instructs the disk reading/writing module 125 to write the header 145 for the journal entry for the first I/O to location p₀ in the journal. The first I/O 155 is 48 k and is written by the disk reading/writing module 125 (via the actuator arm 130) to the I/O operation data location corresponding to the end of the entry's header 145 (i.e., p₀+the 0.5 k allocated for the header 145). The data 155 for the I/O takes up 48 k and thus ends at p₀+0.5 k+48 k. The remaining space allocated for the I/O operation data portion of the I/O (i.e., 64 k−48 k=16 k) is unused. In FIG. 1, the disk reading/writing module 125 also writes a journal entry for a second I/O to the journal. Because the I/O operation's data is 75 k, which is larger than the portion of the journal entry allocated for I/O operation data (i.e., 64 k in the illustrated implementation), the I/O operation data is split across separate chunks 140′, 140″. The journal entry for the second I/O also includes header portions 150, 150′ and I/O operation data portions 160, 160′. Because the architecture 100 utilizes a fixed journal entry size for each chunk 140, the header 150 of the entry for the second I/O is written to a location in the journal at a predetermined offset (i.e., p₀+64.5 k) from the first header 145, independent of the length of the first I/O's data 155 size (i.e., 48 k). This is beneficial in that even if the first I/O 155 is not successfully written to the journal, or is scheduled by the disk reading/writing module's write ordering algorithm to be written temporally after the second I/O 160, 160′, the second I/O's header 150 may be found during recovery because headers 145, 150, 150′ for all I/O operations occur at every p₀+(x*64.5 k) where x is a non-negative number. Thus the data 160, 160′ for the second I/O is recoverable independent of whether the first journal entry is written to the journal or the length/size of the first I/O's data 155.

In the illustrated example, for I/O operations whose data portions are greater than 64 kilobytes, such as the second I/O of FIG. 1, the data 160, 160′ is spread across chunks 140′, 140″ using a “fill first” methodology. For example, the second I/O is 75 kilobytes long. The data 160 for the first 64 kilobytes fills the allocated data portion 110′ of one chunk 140′, and the remaining 11 kilobytes 160′ is written to another chunk 140″. Headers are written to both chunks. Header 150 is written to chunk 140′ and header 150′ is written to chunk 140″. Although the architecture 100 does not utilize all of the contiguous space on the disk for each “tail” of an I/O (in the 75 kilobyte example 53 kilobytes of the second chunk is not used), the gain in actuator arm 130 efficiency by writing in a single pass makes up for this minor deficiency. In some implementations, the header data 150′ for the second I/O operation data 160′ is “junk data” (e.g., does not include any usable data) and the header data 150 of the first header for this I/O includes size and location data for all data 160, 160′ for the I/O. In those implementations, several iterations of junk data headers 150′ and data 160′ “pairs” may exist per true header 150. In other implementations, each data 160, 160′ of an I/O has a separate header 150, 150′ that describes the data portion's size and location. In those implementations, for example, the header 150 describes the size and location of the data 160 and the header 150′ describes the data 160′ as if the single I/O represented by 160 and 160′ is split into multiple I/O operations.

After a power failure, the architecture 100 assists in data recovery. During a recovery operation, the recovery module 135 searches (via the disk reading/writing module 125 and actuator arm 130) the disk 115 for valid journal entries. The recovery module 135 looks for journal entry headers 145, 150, 150′ at locations that are a multiple of the predetermined offset (e.g., p₀+a multiple of 64.5 k for FIG. 1). When the recovery module 135 finds headers 145, 150, 150′ in the journal, the headers' corresponding data portions 155, 160, 160′, are compared against the data store. If an I/O is found in both the journal and the data store, the I/O is considered valid and is retained on the data store. If an I/O is on the data store but not in the journal, then the I/O is typically removed from the data store. Entries that are “not in the journal” may have the header 145, 150, 150′ and/or data portion 155, 160, 160′ missing from the journal (i.e., a valid entry has both a header and data present in the journal). Typically journal entries with a valid header that points to a valid data portion are generally recoverable. Headers that do not contain valid size or location information, or that point to data in the journal that is not found in the data store, are removed or ignored. I/O operations split across multiple journal entries, e.g., 160, 160′, are typically recoverable if all data portions are found in the journal (and have a corresponding journal entry). The architecture 100 is advantageous in that it allows an implementation to find completed headers of journal entries (and correspondingly data) upon recovery, while simultaneously minimizing the movement of the actuator arm 140 as well as the number of writes used to commit data to the disk 115 in a recoverable fashion. Though reference is made herein to the fixed journal entry size being 64.5 k, the journal entry size is exemplary and may be larger or smaller. Likewise, some implementations have two or more contiguous data portions per header. In those implementations, the headers are still written at predetermined intervals in the journal. In the illustrated example, the journal management module 120 and the recovery module 135 are depicted in a processing module 165. The processing module 165 may be, for example, software located within a general purpose computer or the processing module 165 may reside as hardware, firmware, and/or software within a switch located within a network or switching fabric.

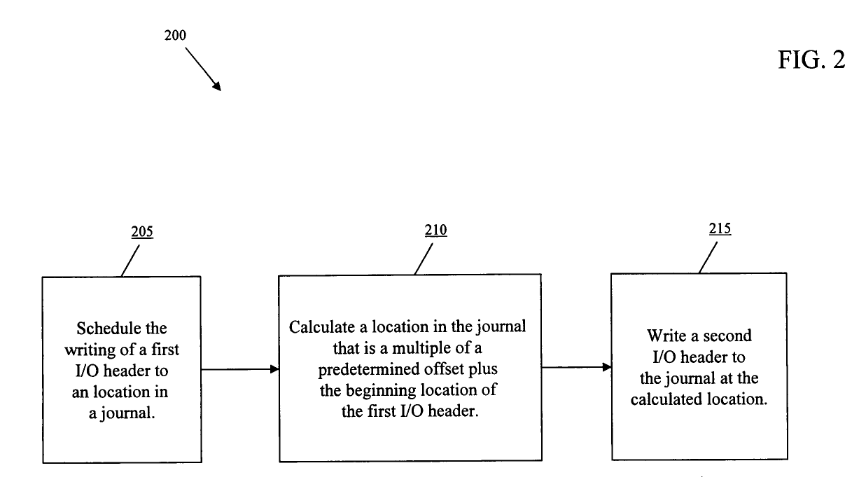

FIG. 2 is a block diagram depicting a method 200 for achieving the predictable architecture 100 depicted in FIG. 1. FIG. 2 depicts the method 200 as follows, but specific implementations are not bound by the order described. The illustrated method 200 begins by scheduling (step 205) the writing of a first journal entry header to a location in a journal. The location of the first header is a function of the architecture 100 and not of the I/O. The location of the header may be based on the blocks or sectors of the disk or on another disk-segmenting scheme. The journal entry header need not be written, only scheduled. The journal management module 120 of FIG. 1, when scheduling the writing of a second I/O, calculates (step 210) a location in the journal that is a multiple of a predetermined offset plus the beginning location of the scheduled first journal entry header. The journal management module then instructs the disk reading/writing module 125 to write (step 215) the second journal entry header to the journal at the calculated location.

In summation, the first journal header is at least planned and the second journal header is then planned (or optionally written) at a multiple of a predetermined offset of the first header's planned location. The predetermined offset is configurable by an implementer of the architecture, with typical implementations involving an offset of 64.5 kilobytes (though, as stated herein, 64.5 k is merely exemplary). Calculating the location of the second I/O as a multiple of a predetermined offset of the location of the first I/O is advantageous in that the location of the second I/O is determinable even if the first journal entry header and/or data is never written to disk. A recovery module (135 of FIG. 1) may then examine locations on the disk that are multiples of the predetermined offsets to find the second I/O, independent of the first I/O. Beneficially, in implementations that schedule the writing of both a header and data (in steps 205 and/or 215), the header and data may be written to the journal in a single pass of the actuator arm (130 of FIG. 1), thus minimizing writes to the disk, i.e., writing the header and data in contiguous locations counts as “one write” since the header and data are written in one pass of the actuator arm.

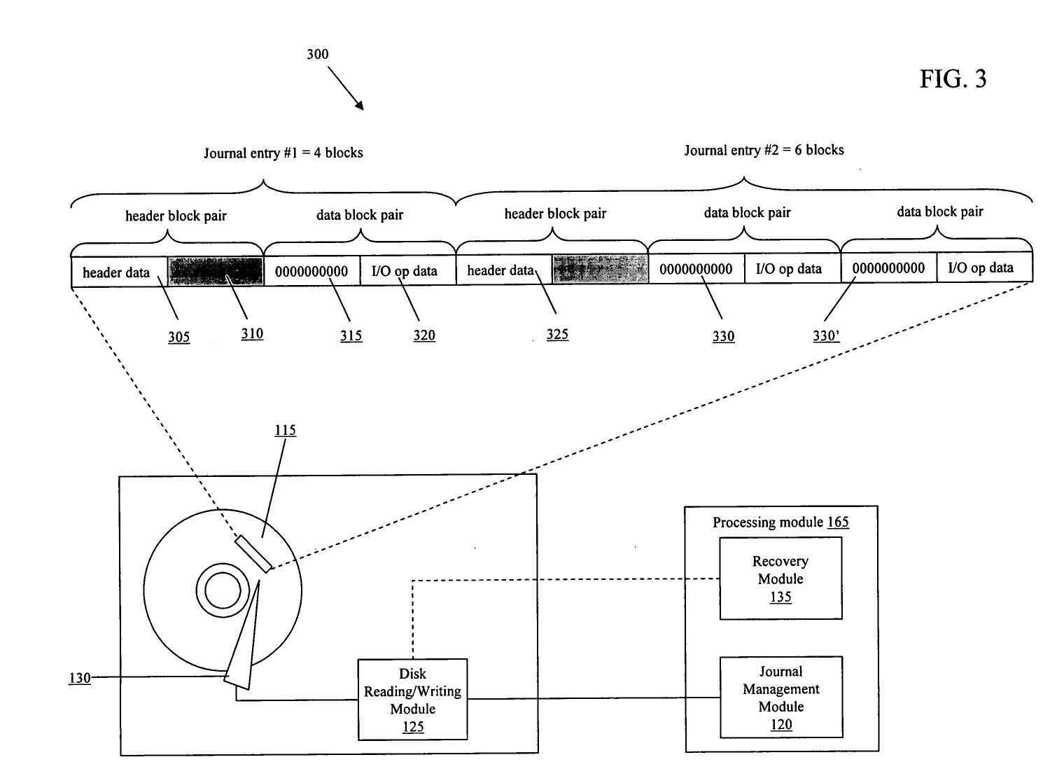

FIG. 3 illustrates another approach to creating a predictable architecture 300. In FIG. 3, a magnetic disk 115, a journal management module 120, a disk reading/writing module 125, an actuator arm 130, and a recovery module 135, are utilized as generally described above with respect to FIG. 1. The recovery module 135 and the journal management module 120 are also housed in the processing module 165 as it is described above with respect to FIG. 1. Paired blocks (e.g., 305 and 310, 315 and 320, etc.) are utilized to distinguish between header data on the disk and I/O operation data on the disk. In a pair of blocks making up a header pair (e.g., 305 and 310), the journal management module 120 (via the disk reading/writing module 125 and the actuator arm 130) writes header data 305 to the odd numbered block. Junk data (e.g., does not include any usable data) 310 is written to the even block and is not utilized. In the I/O operation data pair (e.g., 315 and 320), the journal management module 120 writes known “dummy” data 315 (e.g., data that is not data about the I/O operation, but is usable for identification) to the odd block. The journal management module 120 writes the actual I/O operation data 320 to the even block. In some implementations, the dummy data 315 intended for the odd block of an I/O operation data pair (e.g., 315) is a string of 0s.

During recovery, the recovery module 135 examines the journal and the block pairs in the journal are inspected to determine whether the block pair is a header pair, i.e., there is header data 305 in the odd block, junk data 310 in the even, or a data pair, i.e., dummy data 315 (e.g., 0s) in the odd block, I/O operation data 320 in the even block. The journal management module 120 may also write multiple consecutive data block pairs to the journal. During recovery, the recovery module 135 examines the blocks of the block pairs and determines whether or not the examined block pair is a header 325. This also allows for predictability in that each time there is, for example, a string of 0s 330, 330′ in an odd block, the recovery module 135 determines that the block pair is a data block pair. This establishes consistency and predictability as the recovery module 135 reads through the journal and allows the recovery module 135 to determine which header data combinations were successfully written to disk before the failure. Further, even if the first journal entry (associated with journal entry #1) is not written, the second journal entry (associated with journal entry #2) can be found by finding the header block pair including block 325. Blocks within a pair need not be of the same size. For example, in one implementation, the odd block is 8 bytes and the even block is 512 bytes. In other implementations, the block sizes of a pair are equal. The implementation of the block pairs can be reversed (e.g., dummy data in the header block 305 and header data in the header block 310).

The architecture and methods allow implementations to maintain actuator arm efficiency by helping to minimize writes to the journal while retaining a level of recoverability. From the foregoing, it will be appreciated that the architectures and methods provided afford a simple and effective predictable journal architecture.

The above-described techniques can be implemented in digital electronic circuitry, or in computer hardware, firmware, software, or in combinations of them. The implementation can be as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps can be performed by one or more programmable processors executing a computer program to perform functions of the invention by operating on input data and generating output. Method steps can also be performed by, and apparatus can be implemented as, special purpose logic circuitry, e.g., an FPGA (field programmable gate array) or an ASIC (application-specific integrated circuit). Modules can refer to portions of the computer program and/or the processor/special circuitry that implements that functionality.

The above described techniques can be implemented in a distributed computing system that includes routers, hubs, Storage Area Networks (“SANs”), using Network Attached Storage (“NAS”), Distributed Virtualization Engines (“DVE”) and/or a switching fabric. The components of the system can be interconnected by any form or medium of digital data communication, e.g., a communication network. Examples of communication networks include a local area network (“LAN”) and a wide area network (“WAN”), e.g., the Internet, and include both wired and wireless networks.

The invention has been described in terms of particular embodiments. The alternatives described herein are examples for illustration only and not to limit the alternatives in any way. The steps of the invention can be performed in a different order and still achieve desirable results. Other embodiments are within the scope of the following claims.

1. A predictable journal architecture, the architecture comprising:
a journal comprising:
a first I/O operation data associated with a first size and a first location;
a first journal header disposed at a second location, the first journal header comprising information associated with the first size or first location; and
a second journal header disposed at a third location, the third location being dependent on the second location and independent of the first size or the first location.

2. The architecture of claim 1, wherein the third location is a multiple of an offset from the second location.

3. The architecture of claim 2, wherein the offset comprises a fixed journal entry size.

4. The architecture of claim 2, wherein the offset comprises a fixed block size.

5. The architecture of claim 4, wherein the fixed block size comprises a fourth size, the fourth size comprising a size of a pair of blocks.

6. The architecture of claim 2 further comprising a recovery module.

7. The architecture of claim 6 wherein the recovery module is configured to determine the location of a second I/O operation data based on the offset of the second location.

8. The architecture of claim 7 wherein the recovery module is further configured to compare the first I/O operation data and the second I/O operation data located in the journal to a third I/O, comprising a third journal entry header and a third I/O operation data, located on a data store.

9. The architecture of claim 8 wherein the recovery module is further configured to remove the third I/O from the data store.

10. The architecture of claim 9 wherein the recovery module is configured to remove the third I/O because a copy of the third journal entry header is not located in the journal.

11. The architecture of claim 9 wherein the recovery module is configured to remove the third I/O because a copy of the third I/O operation data is not located in the journal.

12. A method for achieving a predictable journal architecture, the method comprising:
employing a first I/O having a first journal entry header and a first I/O operation data at a first location in a journal; and
employing a second I/O having a second journal entry header and a second I/O operation data in the journal, the second journal entry header located at a predetermined offset from the first location, independent of the length of the first I/O operation data.

13. The method of claim 12, wherein employing comprises reading.

14. The method of claim 12, wherein employing comprises writing.

15. The method of claim 12, wherein the predetermined offset is a multiple of a fixed journal entry size.

16. A method for achieving a predictable journal architecture, the method comprising:
scheduling a first journal entry header to be written to a first location in a journal;
calculating a second location in the journal that is a multiple of a predetermined offset plus the beginning first location; and
writing a second journal entry header to the journal at the second location.

17. The method of claim 16 wherein the first journal entry header is not written to the journal.

18. The method of claim 16 wherein the second journal entry header is written to the journal before the first journal entry header is written to the journal.

19. The method of claim 16 further comprising scheduling a first I/O operation data to be written to a third location, the third location adjacent to the first journal entry header and before the second location.

20. The method of claim 19 further comprising scheduling a second I/O operation data to be written to a fourth location, the fourth location adjacent to the second journal entry header.

21. A method for achieving a predictable journal architecture, the method comprising:
writing a first journal entry header to a journal using a first pair of blocks, the first pair of blocks having a first odd-numbered block and a first even-numbered block, the first journal entry header written to the first odd-numbered block, and
writing a first I/O operation data to the journal using a second pair of blocks, the second pair of blocks having a second odd-numbered block and a second even-numbered block, wherein a constant string is written to the second odd-numbered block and the first I/O operation data is written to the second even-numbered block.

22. The method of claim 21 wherein the constant string comprises a string of 0s.

23. The method of claim 21 the method further comprising:
distinguishing a second journal entry header from the first I/O operation data based on a determination that the second journal entry header is located in a block that does not comprise a string of 0s.
